(19) United States
(12) Patent Application Publication
(10) Pub. No.: US 2007/0028458 A1
(43) Pub. Date: Feb. 8, 2007

(54) Cutting element structure for garden trimmer

(76) Inventor: Lauro Guerra, Gorreggio (RE) (IT)

Correspondence Address: Richard P. Berg, Esq.;c/o LADAS & PARRY, Suite 2100, 5670 Wilshire Boulevard, Los Angeles, CA, 90036-5679, US

(21) Appl. No.: 11/499,865

(22) Filed: Aug. 3, 2006

(30) Foreign Application Priority Data
Aug. 3, 2005 (IT) MI2005U 000288

(51) Int. Cl. B26B 7/00

(52) U.S. Cl. 30/276; 30/347

(57) ABSTRACT

The cutting element structure for a garden trimmer comprises one or more elongate cutting elements which at one of their ends present a body pivotable to the trimmer head.

### TECHNICAL FIELD

The preset invention relates to so-called garden trimmers and more particularly to garden trimmers of the corded head type.

### BACKGROUND

Garden trimmers are known devices for cutting grass, weeds and similar vegetation. They comprise a rotating head from which the two or more ends of a cord of suitable plastic material radially project symmetrically.

The head is rotatably supported at the end of a support and gripping structure, usually in the form of a bar, to the other end of which an internal combustion engine or electric motor is fixed.

The support structure encloses a device for transmitting rotary motion from the motor or engine shaft to the head and also comprises gripping means which enable the user to correctly grip the trimmer for its use.

Two groups of heads currently exist:

a first group of heads in which the cord is wound about a spool with its ends radially projecting symmetrically therefrom through a bush;

a second group of heads provided with a piece of cord retained by a ring nut coaxial to the head and fixable to this latter by screwing.

The bush presents peripheral slits through which the pieces of cord are inserted so that their ends project outwards, or holes provided with non-return catches.

As is well known to the user of trimmers provided with heads of the first group, one of the most annoying and frequent problems is that the two cord pieces projecting from the head, to form the part which materially cuts the vegetation when the head rotates, frequently break at the respective radial exit apertures.

From tests carried out it has been proved that the shearing of the cord at the head exit is due to fatigue. In this respect, by observing the phenomenon under stroboscopic light, it has been found that during trimmer operation the cord, which emerges essentially radially from the head, flexes continuously and irregularly in both directions about the radial direction of the head, through a maximum angle of about 180° (90° towards one side and 900 towards the other side about this radial direction).

It has also been verified that the cutting force discharges on the bush as a traction force, the consequent rubbing heating the cord until it melts, causing it to break.

The heads of the second group comprising cord pieces also present certain problems, and in particular:

the cord pieces have round or square cross-sections of not inconsiderable dimensions (up to 4.2 millimetres) in order to increase their working life, this resulting in a considerable increase in noise and absorbed power;

as they are rigidly fixed by compression, the cord pieces tend to break close to the ring nut, on which the entire cutting force is discharged on encountering rigid obstacles close to the head;

the cord pieces are rather laborious to mount, requiring a tool to release the fixing nut.

The aim of the present invention is therefore to provide a cutting structure for a trimmer by which the said problems of the known art are eliminated.

Within the scope of this aim, specific objects are to provide a cutting structure which:

prevents the cord breaking at the cord exit aperture in the head or considerably reduces the frequency of this phenomenon;

enables the cord to be easily and quickly replaced without excessive force;

limits noise;

provides a higher cutting quality.

the technical aim, together with these and further objects, are attained according to the invention by providing a cutting element structure for garden trimmer in accordance with the accompanying claims.

### BRIEF DESCRIPTION OF THE FIGURES

Further characteristics and advantages will be more apparent from the description of a preferred but non-exclusive embodiment of the cutting element structure for a garden trimmer according to the invention, illustrated by way of non-limiting example in the accompanying figures, in which:

FIG. 1 is a coaxial section through a garden trimmer head provided with a cutting structure of the invention, and with a cutting element shown at a stage during its extraction from the head;

FIG. 2 shows the next stage during the extraction of the cutting element after FIG. 1;

FIG. 3 shows a cutting element of the invention during its insertion into a garden trimmer head;

FIG. 4 shows a garden trimmer head provided with a cutting structure of the invention;

FIG. 5 is a perspective view of the trimmer head with the cutting elements applied;

FIGS. 6, 7, 8, 9 show four different embodiments of a cutting element of the invention; and

FIGS. 10-25 show different cross-sectional forms for the elongate elements or arms of the cutting elements according to the invention.

### DETAILED DESCRIPTION

With reference to said figures, these show a cutting structure for a garden trimmer.

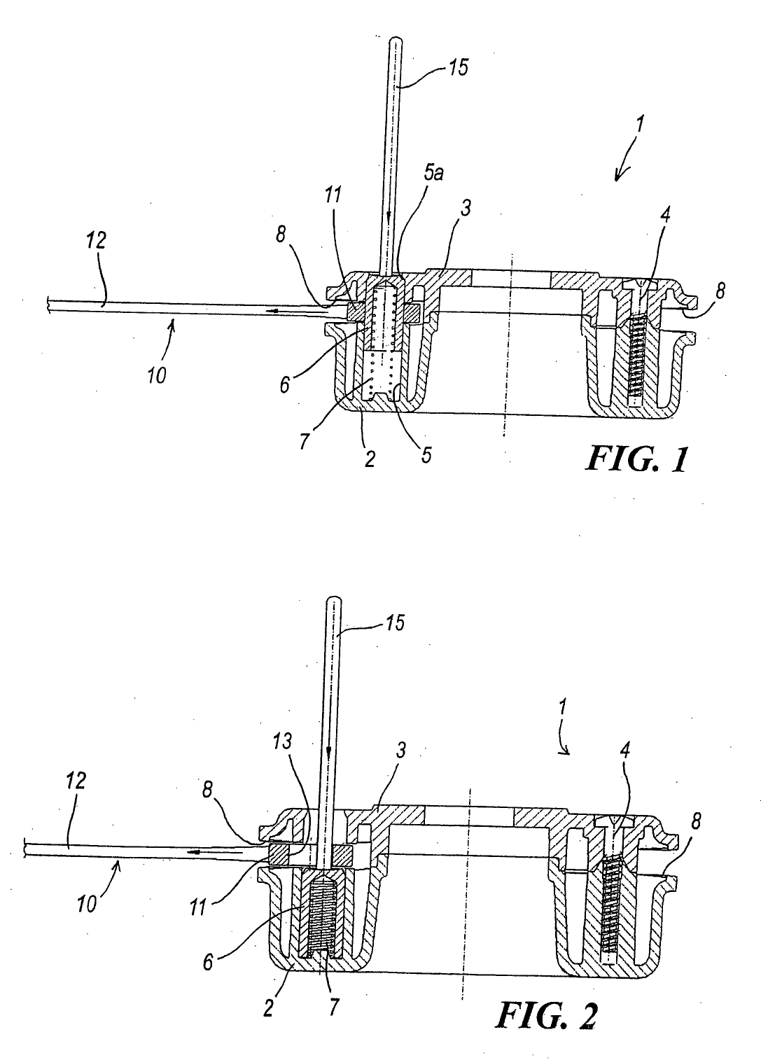

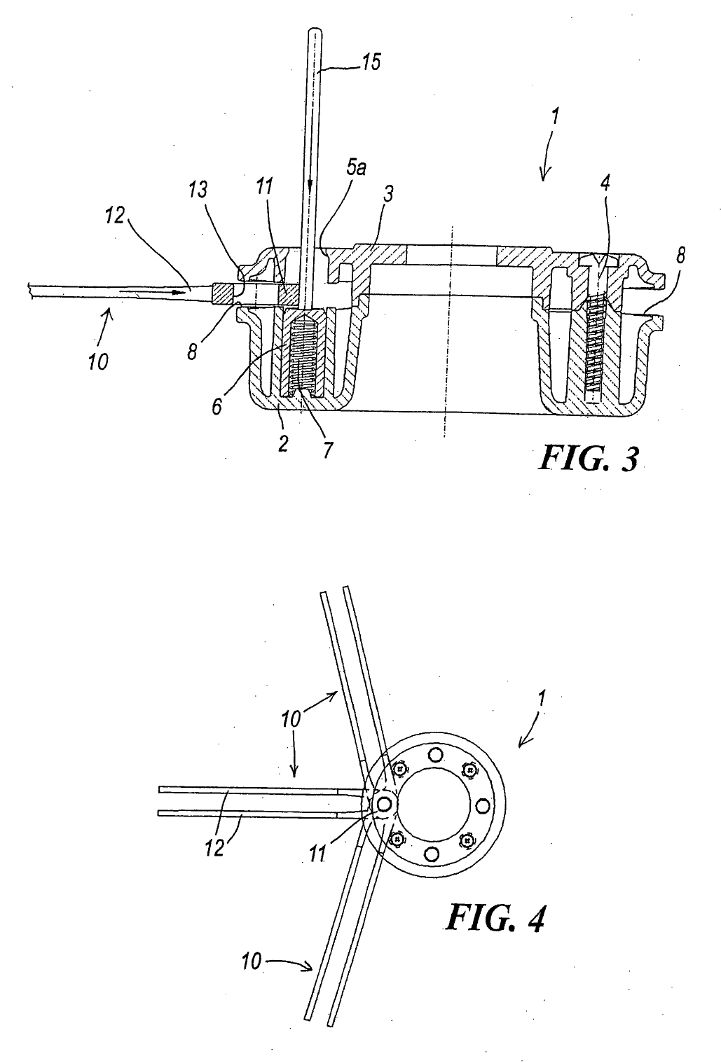

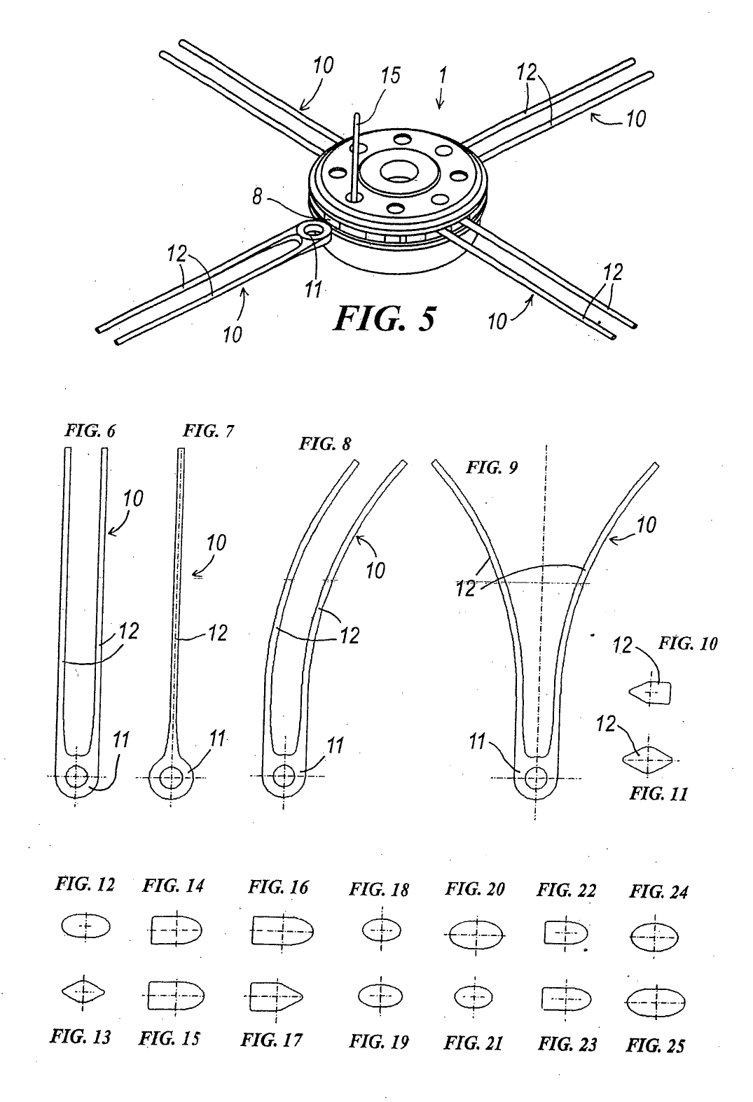

Specifically, FIGS. 1-5 show a garden trimmer head provided with said cutting structure and indicated overall by the reference_numeral 1.

The trimmer head 1 comprises a first casing 2 to which a second casing 3 is fixed by screws 4.

The first casing 2 presents recessed seats 5 into each of which a pin 6 is slidably inserted, movable against and by the action of a spring 7.

Each seat 5 presents a converging (at 5a) free end defining a limit stop for the pin 6.

In addition, the casings 2, 3 laterally define apertures 8 through which pass the cutting elements 10, which are housed in the seat 5 and project from it.

In different embodiments, one, two, three, four or even more cutting elements 10 can project from the trimmer head.

The cutting elements 10 comprise a body 11 connectable to the trimmer head 1.

The body 11 has an annular structure and presents a circular through hole 13 for receiving the trimmer locking pin 6.

In addition, as shown in FIGS. 6-9, there can extend from the body 11 a single elongate element or flexible arm 12 or, in other examples, a pair of elongate elements or flexible arms 12 disposed in a plane perpendicular to the rotation pin, and which can be rectilinear and parallel, or curved in the same direction (FIG. 8), or divergent (FIG. 9), or convergent (arrangement not shown).

In a different example, the elongate elements of each cutting element are four in number, lying in pairs in relative spaced-apart planes perpendicular to the axis of the respective rotation pin.

Advantageously the elongate element or arm or arms of the cutting element 10 have that axis on which the body is pivoted to the trimmer head parallel to the axis of rotation of the head.

The elongate elements or arms present a substantially elliptical or ovoidal or ellipsoidal cross-section, or a cross-section otherwise compressed in the direction of the pivoting pin, to narrow from the pivoted body towards their free end, so that it more easily cuts through the air; other cross-sectional forms (FIGS. 10-25) can also be used.

The body 11 and the cutting element 12 are moulded in one piece from plastic material such as nylon; they also present elastic characteristics which enable them to bend, so limiting risks of breakage.

The operation of the cutting element of the invention is apparent from that described and illustrated and is substantially the following.

It is mounted in the trimmer head (FIG. 3) by pressing, with a tool 15, the pin 6 so that it enters the seat 5, then inserting the element 10 (specifically the body 11) as far as above the pin 6, then withdrawing the tool 15 such that the through hole 13 corresponds with the pin 6, so that when the pin 6 returns to its rest position, it becomes inserted through the hole 13.

Extraction is achieved by pressing the pin 6 with the tool 15 so that the pin 6 withdraws from the through hole 13 and the body 11 mounts the pin 6, after which the tool 15 is withdrawn and the element 10 extracted.

Advantageously, during operation the fact that the particular section through the elongate elements or arms of the cutting element is compressed in the direction of the axis of the pin 6 means that the cutting element produces less noise than cutting elements of the known art.

Moreover, during rotation the cutting element is pivoted on the pin 6 and can slip relative thereto (while rotating). This limits the forces within the elongate elements or arms of the cutting element, hence limiting their breakage close to the head when they encounter rigid obstacles.

By virtue of the particular structure and the particular connection system, the cutting element of the invention can be in the form of elongate elements or arms which are very thin in the direction of the pin 6. In addition to reducing the noise which they generate during rotation, this also enables the vegetation to be very precisely cut (in terms of quality). Different embodiments of the cutting element are possible. For example, in a different embodiment the body 11 is in the form of two shells connected together by screws or snap hooks. The two shells are provided with seats to receive and retain the elongate elements or flexible arms 12. In practice it has been found that garden trimmer cutting structure of the present invention enables cutting elements to be provided which are resistant to tearing, of low noise, and have thin elongate elements or arms which are precise in their cutting.

In practice the materials used and their dimensions can be chosen at will in accordance with requirements and the state of the art.

1. A cutting element structure for a garden trimmer, characterised by comprising one or more elongate cutting elements which at one of their ends present a body pivotable to the trimmer head.

2. A cutting structure as claimed in claim 1, wherein the axis on which the body is pivoted to the garden trimmer head is parallel to the axis of rotation of the head.

3. A cutting structure as claimed in claim 1, wherein the pivotable body presents a through hole into which a relative pin can be inserted for pivoting the head to the trimmer.

4. A cutting structure as claimed in claim 1, wherein the flexible elongate elements have a cross-section the shape of which is compressed in the direction of the pivoting pin.

5. A cutting structure as claimed in claim 1, wherein the cross-section through the flexible elongate elements narrows from the pivotable body towards their free end.

6. A cutting structure as claimed in claim 1, wherein the cross-section through the pivoting elongate elements is ovoidal or ellipsoidal.

7. A cutting structure as claimed in claim 1 wherein the flexible elongate elements of the cutting elements are substantially parallel.

8. A cutting structure as claimed in claim 1, wherein the flexible elongate elements are rectilinear.

9. A cutting structure as claimed in claim 1, wherein the flexible elongate elements are curved.

10. A cutting structure as claimed in claim 1, wherein the pivotable body of the cutting elements and the relative elastic elongate elements form one piece.

11. A cutting structure as claimed in claim 1, wherein the cutting elements are made of plastic material.

12. A cutting structure as claimed in claim 1, wherein the plastic material forming the cutting elements is nylon.

13. A cutting structure as claimed in claim 1, wherein the elongate elements of the cutting elements are one or more in number, disposed in a plane perpendicular to the rotation pin.

14. A cutting structure as claimed in claim 1, wherein the elastic elongate elements of each cutting element are four in number, lying in pairs in relative spaced-apart planes perpendicular to the axis of the relative rotation pin.

15. A cutting structure as claimed in claim 1, wherein the elongate elements present elastic characteristics.

16. A cutting structure as claimed in claim 1, wherein the body is formed as two shells fixable together and provided with seats to receive and retain the elongate elements or flexible arms.
